(19) United States
(12) Patent Application Publication
(10) Pub. No.: US 2010/0003918 A1
(43) Pub. Date: Jan. 7, 2010

(54) WIRELESS DATA COMMUNICATION SYSTEM AND METHODS USING ACTIVE RADIO FREQUENCY TAGS AND WIRELESS TELECOMMUNICATION DEVICES

(75) Inventor: Ajay MALIK, Santa Clara, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/165,881

(22) Filed: Jul. 1, 2008

(51) Int. Cl. H04B 7/00; H04Q 5/22

(52) U.S. Cl. 455/41.2; 340/10.1

(57) ABSTRACT

A wireless data communication system and related operating methods are provided. The system uses active radio frequency (RF) tags to communicate content data to consumer-grade wireless telecommunication devices, in accordance with a wireless local area network (WLAN) protocol. A method of wirelessly providing information to a consumer-grade wireless telephone begins by providing data content to an active RF tag. The active RF tag creates a content message that conveys the data content, and wirelessly transmits the content message in accordance with a designated WLAN data communication protocol. The wireless telephone wirelessly receives the content message in accordance with the WLAN data communication protocol, and then displays indicia of the data content.

### TECHNICAL FIELD

Embodiments of the subject matter described herein relate generally to wireless data communication systems. More particularly, embodiments of the subject matter relate to systems having active radio frequency (RF) tags that wirelessly communicate with consumer-grade wireless telecommunication devices.

### BACKGROUND

Consumer-grade wireless devices have become ubiquitous in modern society. Such wireless devices include cellular telephones, personal digital assistants (PDAs), digital media players, and pagers. Many consumer-grade wireless devices are multifunctional in that they include a combination of features. For example, a smart phone is a single wireless device that includes integrated telephone, email, web browser, and other applications. Indeed, it has become increasingly desirable to wirelessly provide a large amount of information and data to users of consumer devices.

Existing infrastructure and systems support several wireless data delivery techniques that can be used to provide information to consumer devices. One traditional scheme relies on the cellular telephone network to provide data to cellular telecommunication devices. Many cellular service providers offer data packages to their subscribers to accommodate email delivery, web browsing, data downloading, and other features for mobile devices. In addition, wireless local area networks (WLANs) and Wi-Fi enabled hot spots can be used to support compatible dual-mode cellular telecommunication devices. Although WLAN technology provides another mechanism by which consumer-grade wireless devices can receive useful information, a WLAN can be expensive to implement, deploy, and maintain.

There remains a need for an inexpensive and simple system that can provide information to consumer-grade wireless telecommunication devices. In particular, it would be desirable to have a wireless system that can take advantage of modern dual-mode cellular devices in a manner that does not require expensive WLAN infrastructure equipment.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a wireless data communication system;

FIG. 2 is a schematic representation of an embodiment of an active RF tag;

FIG. 3 is a schematic representation of an embodiment of a wireless telecommunication device;

FIG. 4 is a flow chart that illustrates an embodiment of an active RF tag operating process; and

FIG. 5 is a flow chart that illustrates an embodiment of a wireless device operating process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

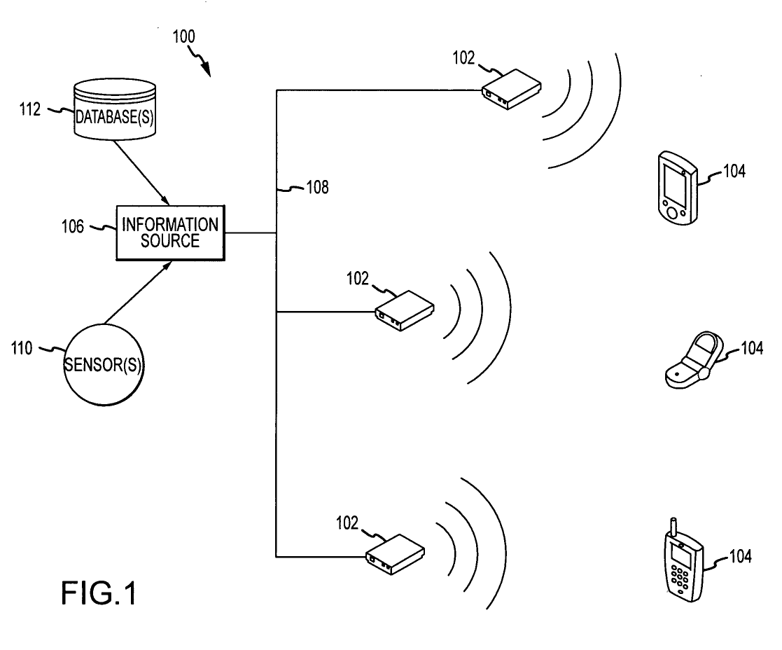

The following description refers to elements or nodes or features being coupled together. As used herein, unless expressly stated otherwise, “coupled” means that one element/node/feature is directly or indirectly joined to (or directly or indirectly communicates with) another element/node/feature, and not necessarily mechanically. Thus, although the schematics shown in FIGS. 1-3 depict exemplary arrangements of elements, additional intervening elements, devices, features, or components may be present in an embodiment of the depicted subject matter.

RF identification (RFID) systems are well known, and RFID systems are commonly utilized for product tracking, product identification, and inventory control in manufacturing, warehouse, transportation, and retail environments. One type of RFID system includes two primary components: a reader (also known as an interrogator); and a passive tag (also known as a transponder). The tag is a miniature device that is capable of responding, via an air channel, to an RF signal generated by the reader. The tag is configured to generate a reflected RF signal in response to the RF signal emitted from the reader. The reflected RF signal is modulated in a manner that conveys identification data back to the reader. The identification data can then be stored, processed, displayed, or transmitted by the reader as needed.

Another type of RFID system employs active RF tags configured to wirelessly communicate with a reader or wireless access device. In this type of system, an active RF tag includes an integrated power supply, such as a battery, a processor, memory, and an RF radio. The active RF tag periodically broadcasts (chirps) RF signals in an attempt to reach a nearby reader or wireless access device, where the RF signals convey data associated with the respective tag, which in turn is associated with a particular asset, package, item, or product. In practice, an active RF tag may function as a transmit-only wireless client in a wireless data communication system, such as a WLAN. In such an environment, the active RF tag can wirelessly communicate with one or more wireless access devices, which may be stand-alone wireless access points or wireless access ports that cooperate with one or more wireless switches located in the WLAN.

The system and operating methods described here can be deployed in the context of “accessories” for consumer-grade wireless devices, such as cellular telephones, PDAs, or the like. The system employs active RF tags as broadcasters of content data intended for reception by compatible wireless devices. The wireless devices receive, process, and display the content data in a user friendly manner. The active RF tags can be deployed in the absence of traditional WLAN infrastructure devices such as wireless access points, and the active RF tags need not be mounted in a permanent location. In certain embodiments, the active RF tags obtain content data (to be transmitted to the wireless user devices) from external information sources such as sensors, updatable databases or data servers, a data network, or the like. In preferred embodiments, the active RF tags are physically and mechanically connected to the external information sources, and they receive data directly from the external information sources.

FIG. 1 is a schematic representation of an embodiment of a wireless data communication system 100. System 100 generally includes, without limitation, at least one active RF tag 102, at least one consumer-grade wireless telecommunication device 104, and at least one information source 106. FIG. 1 depicts a simplified embodiment having only one information source 106 coupled to all of the active RF tags 102. In other embodiments, each active RF tag may be associated with its own respective information source. In practice, information source 106 is physically coupled to active RF tags 102 using a physical data link (or links) 108, as depicted in FIG. 1. In other words, information source 106 is hard wired to active RF tags 102. For the sake of brevity, conventional techniques related to RFID, active RF tags, WLANs, wireless data transmission, and other functional aspects of the systems (and the individual operating components of the systems) may not be described in detail herein.

Information source 106 is suitably configured to provide data content to active RF tags 102. In this regard, the data content may include, convey, or indicate any information that is desired to be sent to active RF tags 102. The data content may be generated, created, or produced by information source 106 itself and/or by one or more sensors 110. Alternatively or additionally, one or more databases 112 can maintain and update the data content, and provide the data content to information source 106 as needed. The data content will reflect the context, application, and operating environment of system 100. In one exemplary embodiment, system 100 represents an onboard vehicle implementation, where information source 106 includes or cooperates with an electronic sensor module for the vehicle. In such an embodiment, sensors 110 may be suitably configured to sense, monitor, or detect operating parameters, functional characteristics, or operating status information for the vehicle, such as, without limitation: tire pressure; mileage; speed; fuel gauge status; battery voltage; engine speed; or the like. Moreover, in such an embodiment, information source 106 may be associated with an electronic control module of the vehicle that processes the sensor data before providing the data content to active RF tags 102. System 100 may also be used in many other applications, environments, and contexts, such as, without limitation: a power circuit monitor that indicates household power consumption; utility meter reading; airport flight status delivery; or advertising and promotional use in shopping centers or stores.

Although not depicted in FIG. 1, alternate embodiments of system 100 may utilize information sources that are embedded into each active RF tag. In such embodiments, the active RF tags may obtain the data content directly from sensors or databases or the active RF tags may be configured as standalone devices.

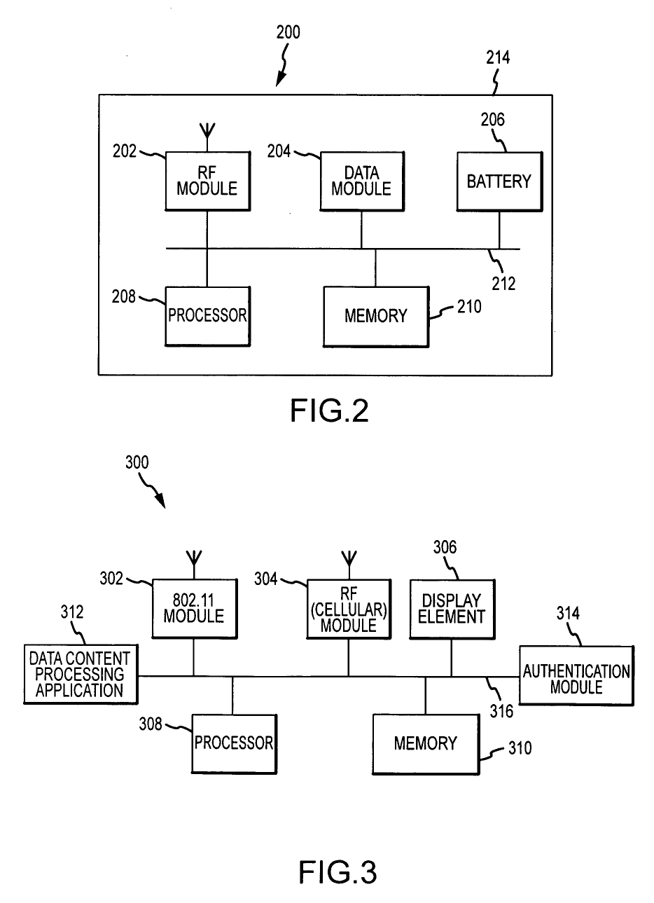

Active RF tags 102 are configured to wirelessly transmit data in accordance with a designated wireless data communication scheme, such as a WLAN protocol. In particular, active RF tags 102 obtain the desired data content, create content messages that convey the desired data content, and broadcast the content messages using the designated wireless data communication scheme. An exemplary embodiment of an active RF tag suitable for use in system 100 is described in detail below with reference to FIG. 2.

Each consumer-grade wireless telecommunication device 104 is suitably configured to wirelessly receive data in accordance with the same designated wireless data communication scheme that is used by active RF tags 102. More specifically, a wireless telecommunication device 104 can receive content messages from active RF tags 102, process the data content contained in the content messages, and display indicia of the data content to the user. In practice, a wireless telecommunication device 104 can be realized using any appropriate platform or configuration. In this regard, a wireless telecommunication device 104 may be realized as a mobile telephone, a mobile PDA, a mobile digital media player, a mobile video game device, a pager, a smart phone, or the like. An exemplary embodiment of a wireless device suitable for use in system 100 is described in detail below with reference to FIG. 3.

FIG. 2 is a schematic representation of an embodiment of an active RF tag 200, which may be utilized in system 100. Active RF tag 200 generally includes, without limitation: an RF module 202; a data module 204; an internal power supply such as a battery 206; a processor 208; and an appropriate amount of memory 210. These and other elements of active RF tag 200 may be interconnected together using a bus 212 or any suitable interconnection arrangement. Such interconnection facilitates communication between the various elements of active RF tag 200. A practical embodiment of active RF tag 200 will include additional components and elements configured to support known or conventional operating features that need not be described in detail herein. Active RF tag 200 will typically be realized as a self-contained component having a package housing 214 that encloses the elements mentioned above. Package housing 214 is relatively compact in size, and certain embodiments may be less than three inches long, less than two inches wide, and less than one inch thick.

RF module 202, which includes a transmitter (or a transceiver in some embodiments), is configured to transmit wireless signals to communicate with compatible devices, including consumer-grade wireless telecommunication devices, using wireless data communication links. RF module 202 may cooperate with a suitably configured RF antenna arrangement to support the particular wireless communication protocol. In exemplary embodiments, RF module 202 is configured to support WLAN data communication protocols and connectivity in compliance with established IEEE Standards, such as 802.11 (any suitable variant). Of course, RF module 202 may be configured to support alternate or additional wireless data communication protocols, including future variations of 802.11. In yet other embodiments, RF module 202 could be configured to support other wireless data communication schemes such as BLUETOOTH®; ZigBee (and other variants of the IEEE 802.15 protocol); IEEE 802.16 (WiMAX or any other variation); Direct Sequence Spread Spectrum; Frequency Hopping Spread Spectrum; cellular/wireless/cordless telecommunication protocols; paging network protocols; wireless hospital or health care facility network protocols such as those operating in the WMTS bands; GPRS; and proprietary wireless data communication protocols such as variants of Wireless USB.

As mentioned above with reference to system 100, active RF tag 200 might receive data content directly from an appropriate information source over a hard wired connection. In this regard, data module 204 generally represents the hardware, software, firmware, processing logic, and/or other components of active RF tag 200 that facilitates the transfer of data content to active RF tag 200. For example, data module 204 may be configured to support 10/100 Mbps Ethernet LAN traffic, data transmitted in accordance with an aircraft or vehicle network protocol, or the like.

Battery 206 is configured to provide operating power to active RF tag 200. A battery or a physically small battery pack is desirable due to the portable and self-contained form factor of active RF tag 200. Battery 206 may be realized as a disposable or rechargeable battery or battery pack. Battery 206 is suitably configured with voltage and current ratings that can support the operation of active RF tag 200. In alternate embodiments, active RF tag 200 can be hard wired or connected to a suitable power supply, e.g., a household AC outlet, the power bus of an aircraft, or the electrical system of a vehicle. In such alternate embodiments, battery 206 need not be utilized.

Processor 208 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor 208 preferably includes processing logic that is configured to carry out the functions, techniques, and processing tasks associated with the operation of active RF tag 200. For example, processor 208 can control the processing of data content associated with an external information source, the creation of content messages, and the transmission of content messages by RF module 202. In this regard, active RF tag 200 is preferably controlled such that it periodically broadcasts content messages in designated time slots.

Memory 210 may be implemented or realized with RAM memory, flash memory, ROM memory, EPROM memory, EEPROM memory, registers, a hard disk, a removable disk, a CD-ROM, or any other form of storage medium known in the art. In addition, memory 210 includes sufficient data storage capacity to support the operation of active RF tag 200. Memory 210 can be coupled to processor 208 such that processor 208 can read information from, and write information to, memory 210. In the alternative, memory 210 may be integral to processor 208. As an example, processor 208 and memory 210 may reside in a suitably configured ASIC.

FIG. 3 is a schematic representation of an embodiment of a consumer-grade wireless telecommunication device 300, which may be utilized in system 100. The illustrated embodiment of device 300 includes, without limitation: a wireless module 302; a cellular communication module 304; a display element 306; a processor 308; an appropriate amount of memory 310; an executable application 312; and an authentication module 314. These and other elements of device 300 may be interconnected together using a bus 316 or any suitable interconnection arrangement. Such interconnection facilitates communication between the various elements of device 300. A practical embodiment of device 300 will include additional components and elements configured to support known or conventional operating features that need not be described in detail herein.

Wireless module 302, which includes a receiver (or a transceiver in certain embodiments), is configured to receive wireless signals from active RF tags in the system. Wireless module 302 may cooperate with a suitably configured RF antenna arrangement to support the particular wireless communication protocol. Wireless module 302 can be configured to support wireless connectivity using any of the techniques, protocols, and schemes mentioned above with reference to RF module 202 (see FIG. 2). In preferred embodiments, wireless module 302 can wirelessly receive content messages in accordance with a designated WLAN data communication protocol, such as that specified by IEEE Specification 802.11 (any suitable variant thereof). In accordance with preferred embodiments, wireless module 302 periodically receives content messages from active RF tags in designated time slots.

Cellular communication module 304, which may be integrated with wireless module 302, is suitably configured to support wireless communication with one or more cellular networks. In other words, wireless module 302 and cellular communication module 304 enable device 300 to function as a dual-mode device (wireless communication using cellular protocols and WLAN protocols, such as 802.11). In practice, cellular communication module 304 can be realized as an RF radio that operates in the desired band. Moreover, cellular communication module 304 may cooperate with a suitably configured RF antenna arrangement to support the particular cellular communication protocol.

Display element 306 can be used to render graphics, text, and other indicia to support operation of device 300. For the embodiments described here, display element 306 is used to display indicia of data content provided by active RF tags. Display element 306, may utilize any known display technology (e.g., LCD, OLED, LED, plasma), and the size and shape of display element 306 may vary to suit the needs of the particular platform.

Processor 308 may be implemented or realized as generally described above for processor 208 (FIG. 2). Processor 308 preferably includes processing logic that is configured to carry out the functions, techniques, and processing tasks associated with the operation of device 300. For example, processor 308 can be used to extract data content from received content messages and process the extracted data content for rendering on display element 306. In addition, processor 308 can be used to carry out cellular telephone operations of device 300.

Memory 310 may be implemented or realized with RAM memory, flash memory, ROM memory, EPROM memory, EEPROM memory, registers, a hard disk, a removable disk, a CD-ROM, or any other form of storage medium known in the art. In addition, memory 310 includes sufficient data storage capacity to support the operation of device 300. Memory 310 can be coupled to processor 308 such that processor 308 can read information from, and write information to, memory 310. In the alternative, memory 310 may be integral to processor 308. As an example, processor 308 and memory 310 may reside in a suitably configured ASIC.

The executable application 312, which may reside in memory 310 for execution by processor 308, is configured to process the data content for device 300. In this regard, executable application 312 may be written in an appropriate manner to suit the needs of the particular implementation of device 300. For example, if the data content includes operating status data for a vehicle, then executable application 312 may process and format the data content in an appropriate manner, and present the data content in a graphical user interface on display element 306. The executable application 312 may also allow the user to search, sort, and analyze the data content as needed.

In certain embodiments, it may be desirable to restrict access to some data content by device 300. Accordingly, authentication module 314 can be utilized to authenticate device 300 and/or the user of device 300. For example, authentication module 314 may be suitably configured to perform authentication procedures for content messages and/or for data content transported in content messages. In operation, authentication module 314 may prompt the user of device 300 to enter a username and/or password upon receipt of a given content message (and/or upon extraction of certain types of data content). Such authentication procedures can provide the system with additional security and privacy enhancements.

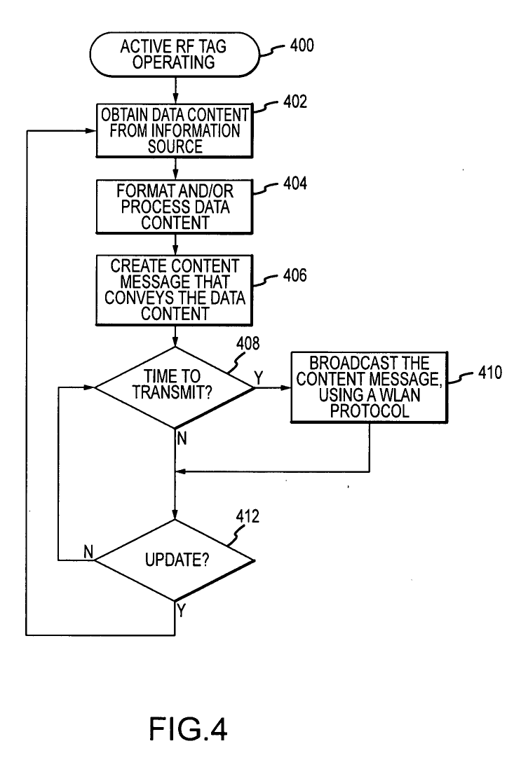

Active RF tags can be utilized as data source accessories for wireless telecommunication devices in the manner described herein. If provided with a source of information, the active RF tags can wirelessly broadcast data content to compatible wireless telecommunication devices (e.g., those that are 802.11 compliant). Operation of an exemplary system will now be described with reference to FIG. 4, which is a flow chart that illustrates an embodiment of an active RF tag operating process 400, which may be performed by an active RF tag configured as described above. The various tasks performed in connection with process 400 may be performed by software, hardware, firmware, or any combination thereof. For illustrative purposes, the following description of process 400 may refer to elements mentioned above in connection with FIGS. 1-3. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

Process 400 may begin with an information source providing data content to an active RF tag, such that the active RF tag obtains the data content (task 402). If necessary, process 400 can then format and/or process the data content (task 404). Task 404 may be desirable to prepare the data content for transmission. The active RF tag creates a suitably formatted and configured content message that conveys the data content (task 406). In practice, a content message may be realized using one or more frames, packets, or beacons that have been formatted for transmission within the wireless data communication system.

For this embodiment, the active RF tag periodically transmits content messages on a predetermined schedule, at regular intervals, or in designated time slots. Thus, process 400 may check whether it is time to transmit the next content message (query task 408). If query task 408 determines that it is time to transmit another content message, then process 400 wirelessly transmits (broadcasts) the content message in accordance with a WLAN data communication protocol, such as 802.11 (task 410). If query task 408 determines that it is not time to transmit, then process 400 may check whether updated data content has been received (query task 412). If not, then process 400 returns to query task 408. Thus, the loop defined by tasks 408, 410, and 412 functions to periodically transmit the same content message at the designated times, until an update is needed.

If query task 412 detects an update in the received data content, then process 400 may return to task 402 to proceed as described above for the new data content. This operating characteristic enables the active RF tag to broadcast updated content messages in response to changes in the underlying data content.

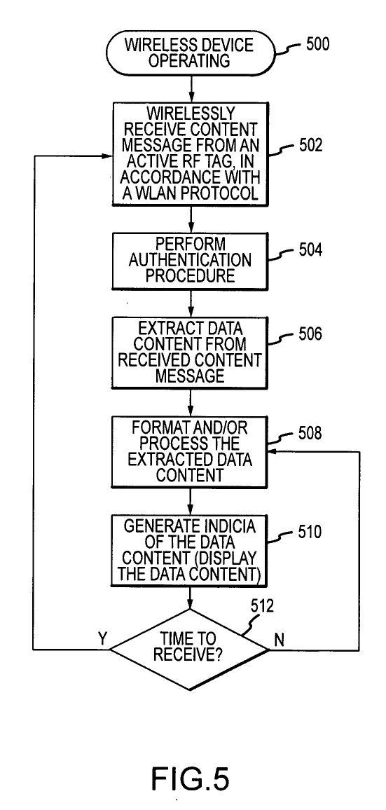

As mentioned previously, the content messages sent by the active RF tags can be received by compatible wireless telecommunication devices within the transmit range of the active RF tags. In this regard, FIG. 5 is a flow chart that illustrates an embodiment of a wireless device operating process 500, which may be performed by a wireless telecommunication device configured as described above. The various tasks performed in connection with process 500 may be performed by software, hardware, firmware, or any combination thereof. For illustrative purposes, the following description of process 500 may refer to elements mentioned above in connection with FIGS. 1-3. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

Process 500 may begin by wirelessly receiving a content message from an active RF tag, in accordance with a WLAN data communication protocol, such as 802.11 (task 502). In some embodiments, the wireless device may perform an appropriate authentication procedure (task 504) to confirm that the user of the wireless device is authorized to receive the content message and/or the data content contained in the content message. If the authentication procedure fails, then process 500 may exit. Assuming that the authentication procedure is successful, process 500 can extract the relevant data content from the received content message (task 506). This allows the wireless device to identify the data content of interest.

If necessary, the wireless device can format and/or process the extracted data content (task 508). Task 508 may be performed to prepare the data content for graphical display and rendering. For this embodiment, process 500 generates indicia of the data content at the wireless device (task 510). In practice, task 510 may be associated with the display of at least some of the data content on the display element of the wireless device.

For this embodiment, the wireless device periodically receives content messages on a predetermined schedule, at regular intervals, or in designated time slots. Thus, process 500 may check whether it is time to receive the next content message (query task 512). If query task 512 determines that it is time to receive another content message, then process 500 returns to task 502 to wirelessly receive the next content message. If query task 512 determines that it is not time to receive, then process 500 may be re-entered at an appropriate point, such as task 508. This allows the wireless device to continue processing and/or displaying the current data content.

The active RF tags, consumer-grade wireless telecommunication devices, and methodologies described herein can be deployed to provide additional data content to users of the wireless devices in an effective and cost efficient manner. This wireless data communication system uses a WLAN protocol, such as 802.11, to broadcast content messages from the active RF tags to compatible wireless devices. Such use of active RF tags as Wi-Fi accessories enables a cellular telephone to receive an abundance of information to which it might not otherwise have access.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A wireless data communication system comprising:
an active radio frequency (RF) tag configured to wirelessly transmit data in accordance with a designated wireless data communication scheme;
an information source physically connected to the active RF tag, and configured to provide data content to the active RF tag; and
a consumer-grade wireless telecommunication device configured to wirelessly receive data in accordance with the designated wireless data communication scheme; wherein
the active RF tag is configured to broadcast content messages that convey the data content; and
the consumer-grade wireless telecommunication device is configured to receive content messages from the active RF tag.

2. The system of claim 1, wherein the consumer-grade wireless telecommunication device is further configured to extract the data content from received content messages, and generate indicia of the data content.

3. The system of claim 2, wherein:
the consumer-grade wireless telecommunication device comprises a display element; and
the consumer-grade wireless telecommunication device is configured to generate indicia of the data content by displaying the data content on the display element.

4. The system of claim 1, wherein the consumer-grade wireless telecommunication device comprises a device selected from the group consisting of a mobile telephone, a mobile personal digital assistant, a mobile digital media player, and a mobile video game device.

5. The system of claim 1, wherein the designated wireless data communication scheme is a wireless local area network (WLAN) protocol.

6. The system of claim 1, wherein the active RF tag periodically broadcasts content messages in designated time slots.

7. The system of claim 1, wherein the information source comprises an electronic sensor module for a vehicle.

8. A method of wirelessly providing information to a consumer-grade wireless telephone, the method comprising:
providing data content to an active radio frequency (RF) tag;
the active RF tag creating a content message that conveys the data content;
the active RF tag wirelessly transmitting the content message in accordance with a wireless local area network (WLAN) data communication protocol;
the consumer-grade wireless telephone wirelessly receiving the content message in accordance with the WLAN data communication protocol; and
the consumer-grade wireless telephone displaying indicia of the data content.

9. The method of claim 8, further comprising the consumer-grade wireless device extracting the data content from the content message.

10. The method of claim 8, wherein the active RF tag periodically transmits content messages in designated time slots.

11. The method of claim 8, wherein:
providing data content is performed by an electronic sensor module of a vehicle; and
the data content comprises operating status information for the vehicle.

12. The method of claim 8, wherein providing data content comprises sending the data content over a physical data link.

13. A consumer-grade wireless telecommunication device comprising:
a wireless module configured to wirelessly receive a content message in accordance with a wireless local area network (WLAN) data communication protocol, the content message originating from an active radio frequency (RF) tag;
a display element; and
a processor coupled to the wireless module and to the display element, the processor being configured to:
extract data content from the content message, wherein the data content is associated with an external information source; and
display indicia of the data content on the display element.

14. The consumer-grade wireless telecommunication device of claim 13, wherein the consumer-grade wireless telecommunication device comprises a device selected from the group consisting of a mobile telephone, a mobile personal digital assistant, a mobile digital media player, and a mobile video game device.

15. The consumer-grade wireless telecommunication device of claim 13, wherein the wireless module is configured to periodically receive content messages from the active RF tag in designated time slots.

16. The consumer-grade wireless telecommunication device of claim 13, wherein the data content indicates operating status information for a vehicle.

17. The consumer-grade wireless telecommunication device of claim 13, further comprising a cellular communication module configured to support wireless communication with a cellular network.

18. The consumer-grade wireless telecommunication device of claim 13, further comprising an authentication module configured to perform an authentication procedure for the content message.

19. The consumer-grade wireless telecommunication device of claim 13, further comprising an authentication module configured to perform an authentication procedure for the data content.

20. The consumer-grade wireless telecommunication device of claim 13, further comprising an executable application configured to process the data content.
